(19) United States
(12) Patent Application Publication
(10) Pub. No.: US 2025/0330660 A1
(43) Pub. Date: Oct. 23, 2025

(54) SERVER AND METHOD

(71) Applicant: 17LIVE Japan Inc., Tokyo (JP)

(72) Inventor: Rong Jun YEH, Taipei City (TW)

(21) Appl. No.: 19/169,540

(22) Filed: Apr. 3, 2025

(30) Foreign Application Priority Data
Apr. 19, 2024 (JP) 2024-068636

(51) Int. Cl. H04N 21/2187; H04N 21/4784

(52) U.S. Cl. CPC H04N 21/2187; H04N 21/4784

(57) ABSTRACT

A server for providing a livestreaming platform includes a circuitry configured to determine, for a first livestreamer in a first rank, whether to move the first livestreamer from the first rank to a different rank, based on a result of comparing a value of a support parameter of the first livestreamer and a value of a support parameter of a different livestreamer in the first rank; determine, for a second livestreamer in a second rank, whether to move the second livestreamer from the second rank to a different rank, based on a result of evaluating a value of a support parameter of the second livestreamer independently of a value of a support parameter of a different livestreamer; and perform an operation to award a reward to a livestreamer, the reward being calculated based on a rank of the livestreamer and a streaming duration of the livestreamer.

### CROSS-REFERENCE TO RELATED APPLICATIONS

This application is based on and claims the benefit of priority from Japanese Patent Application Serial No. 2024-068636 (filed on Apr. 19, 2024), the contents of which are hereby incorporated by reference in their entirety.

### TECHNICAL FIELD

The present disclosure relates to a server and a method.

### BACKGROUND

With the development of IT technology, the way information is exchanged has changed. In the Showa period (1926-1989), one-way information communication via newspapers and television was the main stream. In the Heisei period (1990-2019), with the widespread availability of cell phones and personal computers, and the significant improvement in Internet communication speed, instantaneous interactive communication services such as chat services emerged, and on-demand video streaming services also became popular as storage costs were reduced. And nowadays or in the Reiwa period (2019 to present), with the sophistication of smartphones and further improvements in network speed as typified by 5G, services that enable real-time communication through video, especially livestreaming services, are gaining recognition. The number of users of livestreaming services is expanding, especially among young people, as such services allow people to share the same good time even when they are in the separate locations from each other.

Japanese Patent Application Publication No. 2020-021445 (“the '445 Publication”) discloses a system of paying time-based rewards to livestreamers. According to the '445 Publication, livestreamers are ranked, the rank meter value of a livestreamer depends on the ranking of the livestreamer's streaming points rank in the rank range, and the livestreamer's rank is updated based on the livestreamer's rank meter value. Since rewards are time-based, even beginners can acquire a certain number of rewards that is calculated based on the streaming duration and the standard compensation by keep livestreaming.

There may be only a small number of livestreamers in a rank or rank range. In this case, if the ranking of the livestreamers is used to determine whether to update the livestreamers' rank, the actual efforts or talents of the livestreamers may not be reflected in the updated results. This is because ranking-based decisions always result in some livestreamers receiving positive evaluations and others receiving negative evaluations.

### SUMMARY

In view of the above, one object of the present disclosure is to provide a technique of evaluating efforts made by a livestreamer in a more rightful manner.

An aspect of the present disclosure is related to a server. The server is a server for providing a livestreaming platform. The server includes a circuitry configured to: determine, for a first livestreamer in a first rank of a plurality of ranks, whether to move the first livestreamer from the first rank to a different one of the plurality of ranks, based on a result of comparing a value of a support parameter indicating an amount of support the first livestreamer receives and a value of a support parameter of a different livestreamer in the first rank; determine, for a second livestreamer in a second rank of the plurality of ranks, whether to move the second livestreamer from the second rank to a different one of the plurality of ranks, based on a result of evaluating a value of a support parameter of the second livestreamer independently of a value of a support parameter of a different livestreamer; and perform an operation to award a reward to a livestreamer, the reward being calculated based on a rank of the livestreamer and a streaming duration of the livestreamer.

It should be noted that the components described throughout this disclosure may be interchanged or combined. The components, features, and expressions described above may be replaced by devices, methods, systems, computer programs, recording media containing computer programs, etc. Any such modifications are intended to be included within the spirit and scope of the present disclosure.

### ADVANTAGEOUS EFFECTS OF THE DISCLOSURE

According to the aspects of the disclosure, efforts made by a livestreamer can be evaluated in a more rightful manner.

### BRIEF DESCRIPTION OF THE DRAWINGS

FIG. 1 schematically illustrates a configuration of a livestreaming system according to one embodiment of the disclosure.

FIG. 2 is a block diagram showing functions and configuration of a user terminal in FIG. 1.

FIG. 3 is a block diagram showing functions and configuration of a server in FIG. 1.

FIG. 4 is a data structure diagram showing an example of a stream DB in FIG. 3.

FIG. 5 is a data structure diagram showing an example of a user DB in FIG. 3.

FIG. 6 is a data structure diagram showing an example of a gift DB in FIG. 3.

FIG. 7 is a data structure diagram showing an example of a criteria DB in FIG. 3.

FIG. 8 is a flowchart showing a series of steps to award a time-based reward in a livestreaming system.

FIG. 9 is a representative screen image of a livestreaming room screen appearing on the display of a viewer's user terminal.

FIG. 10 is a representative screen image of a rank information display screen appearing on the display of the user terminal of a resting livestreamer.

FIG. 11 is a block diagram showing an example of hardware configuration of an information processing device according to the embodiment.

### DESCRIPTION OF THE PREFERRED EMBODIMENTS

Like elements, components, processes, and signals throughout the figures are labeled with same or similar designations and numbering, and the description for the like elements will not be hereunder repeated. For purposes of clarity and brevity, some of the components that are less related and thus not described are not shown in the figures.

In a livestreaming system relating to an embodiment, a livestreamer is offered a time-based reward system. A time-based reward is compensation calculated based on a duration, and the product of multiplying a livestreamer's hourly rate (the unit price of compensation per hour) by the livestreamer's streaming duration. The hourly rate used to calculate the time-based reward increases as the livestreamer's rank rises. The livestreamer has a support score, which rises as the livestreamer gets support actions such as gifts or cheers (time-recovery free items) from users within or outside livestreams. At the closing time of the day, the system refers to the support score of the livestreamer to determine whether the livestreamer's rank changes. In the present embodiment, the ranks of livestreamers may be determined using both the relative and absolute evaluations. For example, relative evaluations are used for a low rank into which a relatively large number of livestreamers are sorted. In this case, the livestreamers are ranked by their support score, and the rank score of the livestreamers ranked in the top X % is increased. For a high rank into which a relatively small number of livestreamers are sorted, absolute evaluations are used. In this case, the rank score of a livestreamer is raised if the support score of the livestreamer exceeds a fixed, rank-specific threshold. The system raises the rank of a livestreamer if the livestreamer's rank score reaches a predetermined upper limit and lowers the rank of the livestreamer if the livestreamer's rank score reaches a predetermined lower limit.

Since the ranks of livestreamers are determined based on both relative and absolute evaluations as described above, appropriate evaluation criteria can be introduced for the respective ranks according to the characteristics of the ranks. This will result in encouraging fair competition among livestreamers, improving the quality of livestreams as a whole, and providing a livestreaming system that better rewards livestreamers for their hard work. For example, relative evaluations are used for ranks into which a large number of livestreamers are sorted. At each closing time, there are thus always livestreamers whose rank score rises and livestreamers whose rank score drops, which can encourage healthy competition among the livestreamers. Unlike absolute evaluations such as fixed thresholds, a livestreamer who is currently in the top position is not guaranteed his/her position the entire time until the closing time comes. On the contrary, the current top livestreamer may fall in the rankings if the other livestreamers become more engaged in their activities toward the closing time. This may motivate the current top livestreamer to continue to offer high-quality livestreaming until the closing time comes. This can contribute to enhancing the quality of livestreams as a whole.

Absolute evaluations are employed for ranks into which a small number of livestreams are sorted. Individual livestreamer's efforts can be independently evaluated. For ranks with a small number of livestreamers, it is quite possible that most or all of the livestreamers are doing their best. If relative evaluations are applied for such ranks, some of the livestreamers may lose their rank score even though they are making efforts. The converse is also true. That is to say, if most or all of the livestreamers are not working hard, applying relative evaluation may allow some livestreamers to have a raised rank score without making efforts. Employing absolute evaluations can prevent or eliminate such issues. For example, for relatively high ranks, there are only a small number of livestreamers, and the respective livestreamers usually have high quality, experience and motivation. Therefore, absolute evaluations can more rightfully assess the livestreamers' efforts. In addition, a high threshold can be correspondingly set for a high rank. This can motivate the livestreamers to continuously provide high-quality livestreams, thereby improving the quality of livestreams as a whole.

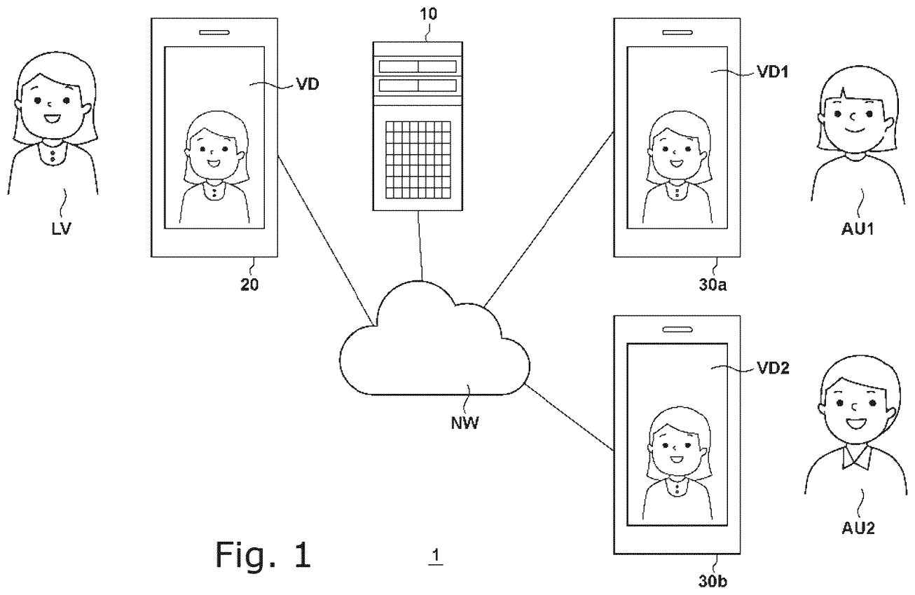

FIG. 1 schematically illustrates the configuration of a livestreaming system 1 according to one embodiment of the disclosure. The livestreaming system 1 provides an interactive livestreaming service that allows a livestreamer LV (also referred to as a liver or streamer) and viewers AU (also referred to as audience) (AU1, AU2, . . . ) to communicate in real time. As shown in FIG. 1, the livestreaming system 1 includes a server 10, a user terminal 20 on the livestreamer side, and user terminals 30 (30a, 30b . . . ) on the audience side. In addition to the livestreamer who is livestreaming and the viewers who are watching the livestream, there may be users who have logged in the livestreaming platform but is neither livestreaming nor watching the livestream. Such users are herein referred to as active users. The livestreamer, viewers, and active users may be collectively referred to as users. The server 10 may be constituted by one or more information processing devices connected to a network NW. The user terminals 20 and 30 may be, for example, mobile terminal devices such as smartphones, tablets, laptop PCs, recorders, portable gaming devices, and wearable devices, or may be stationary devices such as desktop PCs. The server 10, user terminal 20, and user terminals 30 are interconnected so as to be able to communicate with each other over the various wired or wireless networks NW.

The livestreaming system 1 involves the livestreamer LV, the viewers AU, and an administrator (not shown) who manages the server 10. The livestreamer LV is a person who broadcasts contents in real time by recording the contents with his/her user terminal 20 and uploading them directly to the server 10. Examples of the contents may include the livestreamer's own songs, talks, performances, fortune-telling, gameplays, and any other contents. The administrator provides a platform for livestreaming contents on the server 10, and also mediates or manages real-time interactions between the livestreamer LV and the viewers AU. The viewers AU access the platform through their user terminals 30 to select and view a desired content. During livestreaming of the selected content, the viewer AU performs operations to comment, cheer, or ask fortune-telling via the user terminal 30, the livestreamer LV who is delivering the content responds to such a comment, cheer, or request and such response is transmitted to the viewer AU via video and/or audio, thereby establishing an interactive communication.

As used herein, the term “livestreaming” or “livestream” may mean a mode of data transmission that allows a content recorded at the user terminal 20 of the livestreamer LV to be played and viewed at the user terminals 30 of the viewers AU substantially in real time, or it may mean a live broadcast realized by such a mode of transmission. The livestreaming may be achieved using existing livestreaming technologies such as HTTP Live Streaming, Common Media Application Format, Web Real-Time Communications, Real-Time Messaging Protocol and MPEG DASH. The livestreaming includes a transmission mode in which, while the livestreamer LV is recording contents, the viewers AU can view the contents with a certain delay. The delay is acceptable as long as interaction between the livestreamer LV and the viewers AU can be at least established. Note that the livestreaming is distinguished from so-called on-demand distribution, in which contents are entirely recorded and the entire data is once stored on the server and the server provides users with the data at any subsequent time upon request from the users.

The term “video data” herein refers to data that includes image data (also referred to as moving image data) generated using an image capturing function of the user terminals 20 and 30 and audio data generated using an audio input function of the user terminals 20 and 30. Video data is reproduced in the user terminals 20 and 30, so that the users can view contents. In this embodiment, it is assumed that between video data generation at the livestreamer's user terminal and video data reproduction at the viewer's user terminal, processing is performed onto the video data to change its format, size, or specifications of the data, such as compression, decompression, encoding, decoding, or transcoding. However, such processing does not substantially change the content (e.g., video images and audios) represented by the video data, so that the video data after such processing is herein described as the same as the video data before such processing. In other words, when video data is generated at the livestreamer's user terminal, transmitted via the server 10, and then reproduced at the viewer's user terminal, the video data generated at the livestreamer's user terminal, the video data that passes through the server 10, and the video data received and reproduced at the viewer's user terminal are all the same video data.

As used herein, the term “streaming duration” is a parameter associated with a livestream and refers to the length of time the livestream lasts. The streaming duration is calculated independently from whether the corresponding livestream is watched by any viewers. As used herein, “total streaming duration” is a parameter associated with a livestreamer and is obtained by adding up the durations of livestreams performed by the livestreamer in a given period of time. As used herein, “view duration” is a parameter associated with a pair of a viewer and a livestreamer and refers to the length of time during which the viewer has viewed a livestream of the livestreamer. As used herein, “viewed duration” is a parameter associated with a livestreamer and refers to the length of time during which a livestream of the livestreamer is viewed by a viewer. Here, the viewer may represent a single randomly selected viewer, a subset of randomly selected viewers, or all viewers. Alternatively, the viewed duration may represent an average calculated over viewers. The viewed duration is used as an indicator of the extent to which the livestreamer's livestream is viewed by the viewer. As used herein, “total viewed duration” is a type of viewed duration and is obtained by adding up the viewed durations of all viewers who view the livestreamer's livestream in a given period of time.

For example, if viewers B, C, and D view a livestream delivered by a livestreamer A for 2 hours, 3 hours, and 4 hours, respectively, in a given period of time, the total viewed duration can be calculated as follows.

$$View duration of Viewer B = 2 hours$$

$$View duration of Viewer C = 3 hours$$

$$View duration of Viewer D = 4 hours$$

$$Total viewed duration of livestreamer$$

$$A ’ s livestream = 2 + 3 + 4 = 9 hours$$

$$Average viewed duration of livestreamer$$

$$A ’ s livestream = 9 / 3 = 3 hours$$

Viewed duration of livestreamer A's livestream: It can be either total viewed duration or average viewed duration.

In the example in FIG. 1, a livestreamer LV is livestreaming his/her talk. The user terminal 20 of the livestreamer LV generates video data by recording images and sounds of the livestreamer LV who is talking, and the generated video data is transmitted to the server 10 over the network NW. At the same time, the user terminal 20 displays the recorded video image VD of the livestreamer LV on the display of the user terminal 20 to allow the livestreamer LV to check the livestream currently performed.

The respective user terminals 30a and 30b of the viewers AU1 and AU2, who have requested the platform to enable them to view the livestream of the livestreamer LV, receive video data related to the livestream over the network NW and reproduce the received video data, to display video images VD1 and VD2 on the displays and output audio through the speakers. The video images VD1 and VD2 displayed at the user terminals 30a and 30b, respectively, are substantially the same as the video image VD captured by the user terminal 20 of the livestreamer LV, and the audio outputted at the user terminals 30a and 30b is substantially the same as the audio recorded by the user terminal 20 of the livestreamer LV.

Recording of the images and sounds at the user terminal 20 of the livestreamer LV and reproduction of the video data at the user terminals 30a and 30b of the viewers AU1 and AU2 are performed substantially simultaneously. The viewer AU1 may type a comment about the talk of the livestreamer LV on the user terminal 30a, and the server 10 may display the comment on the user terminal 20 of the livestreamer LV in real time and also display the comment on the user terminals 30a and 30b of the viewers AU1 and AU2, respectively. The livestreamer LV may read the comment and develop his/her talk to cover and respond to the comment, and the video and sound of the talk are output on the user terminals 30a and 30b of the viewers AU1 and AU2, respectively. This interactive action is recognized as establishment of a conversation between the livestreamer LV and the viewer AU1. In this way, the livestreaming system 1 realizes a livestream that enables the interactive communication, not one-way communication.

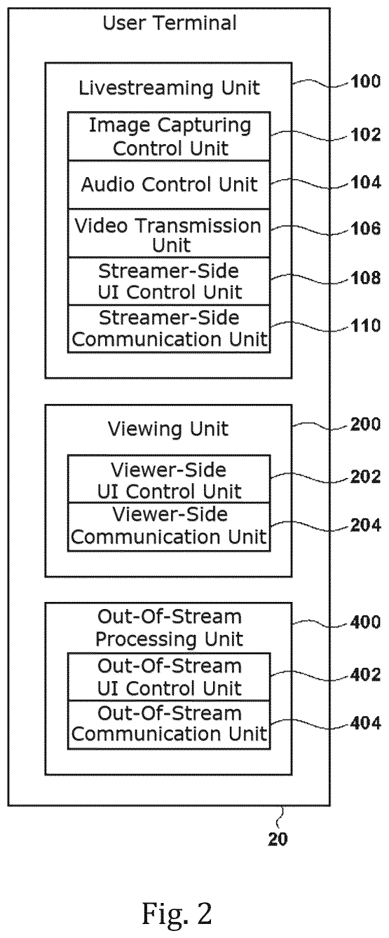

FIG. 2 is a block diagram showing functions and configuration of the user terminal 20 of FIG. 1. The user terminals 30 have the same functions and configuration as the user terminal 20. The blocks in FIG. 2 and the subsequent block diagrams may be realized by elements such as a computer CPU or a mechanical device in terms of hardware, and can be realized by a computer program or the like in terms of software. The blocks shown in the drawings are, however, functional blocks realized by cooperative operation between hardware and software. Therefore, it is understood by those skilled in the art that these functional blocks can be realized in various forms by combining hardware and software.

The livestreamer LV and the viewers AU download and install a livestreaming application program (hereinafter referred to as a livestreaming application), onto the user terminals 20 and 30 from a download site over the network NW. Alternatively, the livestreaming application may be pre-installed on the user terminals 20 and 30. When the livestreaming application is executed on the user terminals 20 and 30, the user terminals 20 and 30 communicate with the server 10 over the network NW to implement various functions. Hereinafter, the functions implemented by (processors such as CPUs of) the user terminals 20 and 30 running the livestreaming application will be described as functions of the user terminals 20 and 30. These functions are realized in practice by the livestreaming application on the user terminals 20 and 30. In any other embodiments, these functions may be realized by a computer program written in a programming language such as HTML (HyperText Markup Language), which is transmitted from the server 10 to web browsers of the user terminals 20 and 30 over the network NW and executed by the web browsers.

The user terminal 20 includes a streaming unit 100 for generating a video data in which the user's image and sound are recorded and providing the video data to the server 10, a viewing unit 200 for acquiring and reproducing the video data from the server 10, and an out-of-stream processing unit 400 for processing requests made by active users. The user activates the streaming unit 100 to livestream, the viewing unit 200 to view a livestream, and the out-of-livestream processing unit 400 to look for a livestream, view a livestreamer's profile, or watch an archive. The user terminal having the livestreaming unit 100 activated is the livestreamer's terminal, i.e., the user terminal that generates video data, the user terminal having the viewing unit 200 activated is the viewer's terminal, i.e., the user terminal that reproduces video data, and the user terminal having the out-of-livestream processing unit 400 activated is the active user's terminal.

The streaming unit 100 includes an image capturing control unit 102, an audio control unit 104, a video transmission unit 106, a streamer-side UI control unit 108, and a streamer-side communication unit 110. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time.

The streamer-side UI control unit 108 controls a UI for the livestreamer. The streamer-side UI control unit 108 is connected to a display (not shown in FIG. 2), and displays a video image on the display by reproducing the video data that is to be transmitted by the video transmission unit 106. The streamer-side UI control unit 108 is also connected to input means (not shown in FIG. 2) such as touch panels, keyboards, and displays, and obtains the livestreamer's input via the input means. The streamer-side UI control unit 108 superimposes a predetermined frame image on the video image. The frame image includes various user interface objects (hereinafter simply referred to as “objects”) for receiving inputs from the livestreamer, comments entered by the viewers, and information obtained from the server 10. The streamer-side UI control unit 108 receives, for example, the livestreamer's inputs made by the livestreamer tapping the objects.

The streamer-side communication unit 110 controls communication with the server 10 during a livestream. The streamer-side communication unit 110 transmits the content of the livestreamer's input that has been obtained by the streamer-side UI control unit 108 to the server 10 over the network NW. The streamer-side communication unit 110 receives various information associated with the livestream from the server 10 over the network NW.

The viewing unit 200 includes a viewer-side UI control unit 202 and a viewer-side communication unit 204. The viewer-side communication unit 204 controls communication with the server 10 during a livestream. The viewer-side communication unit 204 receives, from the server 10 over the network NW, video data related to the livestream in which the livestreamer and the viewer participate.

The viewer-side UI control unit 202 controls the UI for the viewer. The viewer-side UI control unit 202 is connected to a display and a speaker (not shown in FIG. 2), and reproduces the received video data so that video images are displayed on the display and sounds are output through the speaker. The state where the images and sounds are respectively output through the display and speaker can be referred to as “the video data is reproduced”. The viewer-side UI control unit 202 is also connected to input means (not shown in FIG. 2) such as touch panels, keyboards, and displays, and obtains the viewer's input via the input means. The viewer-side UI control unit 202 superimposes a predetermined frame image on an image generated from the video data obtained from the server 10. The frame image includes various objects for receiving inputs from the viewer, comments entered by the viewer, and information obtained from the server 10. The viewer-side communication unit 204 transmits the content of the viewer's input that has been obtained by the viewer-side UI control unit 202 to the server 10 over the network NW.

The out-of-stream processing unit 400 includes an out-of-stream UI control unit 402 and an out-of-stream communication unit 404. The out-of-stream UI control unit 402 controls a UI for the active user. For example, the out-of-stream UI control unit 402 generates a livestream selection screen and shows the screen on the display. The livestream selection screen presents a list of livestreams to which the active user is currently invited to participate, to allow the active user to select a livestream. The out-of-stream UI control unit 402 generates a profile screen for any user and shows the screen on the display. The out-of-stream UI control unit 402 plays back archived data that is generated by recording past livestreams.

The out-of-stream communication unit 404 controls communication with the server 10 that takes place outside a livestream. The out-of-livestream communication unit 404 receives, from the server 10 over the network NW, information necessary to generate the livestream selection screen, information necessary to generate the profile screen, and archived data. The out-of-stream communication unit 404 transmits the content of the active user's input to the server 10 over the network NW.

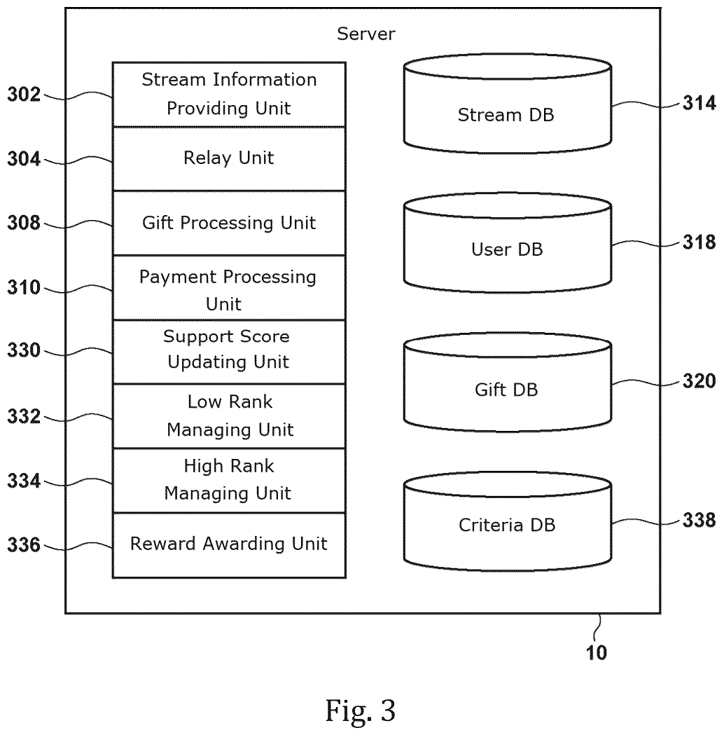

FIG. 3 is a block diagram showing functions and configuration of the server 10 of FIG. 1. The server 10 includes a livestreaming information providing unit 302, a relay unit 304, a gift processing unit 308, a payment processing unit 310, a stream DB 314, a user DB 318, a gift DB 320, a support score updating unit 330, a low rank managing unit 332, a high rank managing unit 334, a reward awarding unit 336 and a criteria DB 338.

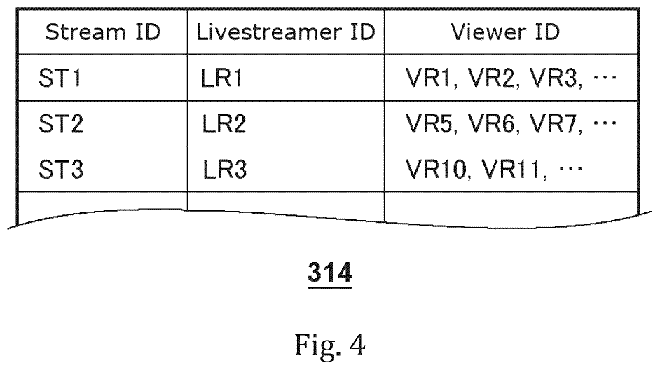

FIG. 4 is a data structure diagram showing an example of the stream DB 314 of FIG. 3. The stream DB 314 holds information regarding livestreams currently taking place. The stream DB 314 stores a stream ID for identifying a livestream on a livestreaming platform provided by the livestreaming system 1, a livestreamer ID, which is a user ID for identifying the livestreamer who provides the livestream, and a viewer ID, which is a user ID for identifying a viewer of the livestream, in association with each other.

In the livestreaming platform provided by the livestreaming system 1 of the embodiment, when a user delivers a livestream, the user is referred to as a livestreamer, and when the same user views a livestream delivered by another user, the user is referred to as a viewer. Therefore, the distinction between a livestreamer and a viewer is not fixed, and a user ID registered as a livestreamer ID at one time may be registered as a viewer ID at another time.

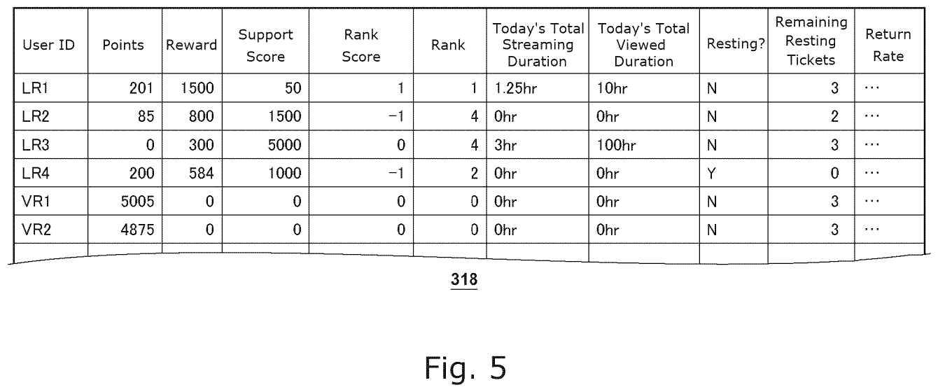

FIG. 5 is a data structure diagram showing an example of the user DB 318 of FIG. 3. The user DB 318 holds information regarding users. The user DB318 stores a user ID for identifying a user, points held by the user, rewards awarded to the user, the support score of the user, the rank score of the user, the rank of the user, today's total streaming duration of the user, today's total viewed duration of the user, a resting flag for indicating whether the user is resting in a round in which the user participates (hereinafter referred to as “current round”), the number of remaining resting tickets owned by the user, and a return rate related to profit distribution for the user, in association with each other.

The points are an electronic representation of value circulated in the livestreaming platform. The user can purchase the points using a credit card or other means of payment. The reward is an electronic representation of value defined in the livestreaming platform and is used to determine the amount of money the livestreamer receives from the administrator of the livestreaming platform. In the livestreaming platform, when a viewer gives a gift to a livestreamer within or outside a livestream, the viewer's points are consumed and, at the same time, the livestreamer's reward is increased by an amount equal to the product of multiplying the price points of the gift with the return rate. In the present embodiment, the return rate for a livestreamer is independently determined from the rank, rank score, or support score of the livestreamer. For example, the return rate may be set based on a contract between the livestreamer and the administrator. Different livestreamers may have different return rates or the same return rate.

The support score is a support parameter that indicates the amount of supports the user receives as a livestreamer from other users. In the present embodiment, the support score, which is a numerical value, is used as the support parameter. In other embodiments, however, the support parameter may be the value and/or number of points earned, the number of comments received, the value and/or number of gifts received, the viewed duration, or any combination thereof, or may be a parameter calculated based on at least one of them.

The support score of the livestreamer represents how much other users are engaged with the livestreamer. The support score of the livestreamer is updated based on the support actions taken by other users for the livestreamer. The support actions include, for example, giving gifts and making comments within and outside livestreams, viewing livestreams, and sharing the livestreamer and the livestreamer's livestreams. The support score of the livestreamer depends on: the amount of gifts the livestreamer receives within livestreams; the amount of gifts the livestreamer receives outside livestreams, the number and/or frequency of comments posted in livestreams delivered by the livestreamer; the number and/or frequency of comments posted outside livestreams, for example in the livestreamer's timeline or by direct messages sent to the livestreamer; the viewed duration of the livestreamer; the amount of cheers sent within the livestreams delivered by the livestreamer; the number of viewers (total, average, etc.), the number of shares, the number of viewers who give a gift, and so on. For example, the expression for calculating the support score is set such that the support score increases as the number of gifts the livestreamer receives within or outside livestreams increases, and/or as the number of comments increases, and/or as the viewed duration increases, and/or as the amount of cheers increases. The support score may rise or drop depending on the support actions. For example, the support score for the livestreamer may drop if no support actions are performed for the livestreamer within a given period of time.

The support score of the livestreamer may depend on the attributes of the users who give supports to the livestreamer. For example, the support score may be set such that, for the same amount of support actions, the value of the support score increases more considerably when a large number of users give supports than when a small number of specific users give support. For example, the support score may change by +10 if the livestreamer receives gifts worth 1000 points from a single user, while the support score may change by +15 if the livestreamer receives 200 points each from five users.

In the livestreaming platform relating to the present embodiment, the rank score and rank are updated periodically. The updates may happen daily, weekly,/monthly or yearly. In the following description, the updates happen daily, and the single cycle of updates is referred to as a round. The closing time for finalizing the support score in the current round for updating the rank score and rank and resetting the support score to the initial value (0) for the next round is set at midnight.

Based on the value of the support score finalized at the closing time of each round, the livestreamer's rank score may stay or change. The livestreamer's rank score is updated based on the result of assessing the value of the support score of the livestreamer according to the criteria specific to the corresponding rank, which are stored in the criteria DB 338 described below.

The livestreamer's rank stays or changes depending on the value of the rank score updated at the closing of each round. The livestreamer's rank stays the same, increases or drops depending on the updated value of the livestreamer's rank score. In the present embodiment, if the updated value of the livestreamer's rank score reaches 2, the livestreamer' rank increases by 1, and the rank score is reset to the initial value (0). If the updated value of the livestreamer's rank score reaches −2, the livestreamer's rank falls by 1, and the rank score is reset to the initial value (0). In the other cases, the rank stays unchanged (does not change). The rank can be considered as an indicator of what the user has achieved as a livestreamer on the livestreaming platform.

The item “today's total streaming duration” denotes the cumulative total of the livestreamer's streaming durations in the current round. The item “today's total viewed duration” denotes the total of the viewed durations of the livestreamer in the current round.

The term “resting ticket” indicates a digital item given to the user. A fixed number of resting tickets are given to each user by the administrator on a periodic basis, e.g., once a month or once a year. The livestreamer may designate a round and use a resting ticket in the designated round. This excludes the livestreamer from the rank score/rank updating process for the designated round. In other words, the livestreamer can keep the rank score and rank unchanged in the designated round. If the livestreamer designates the next round and uses a resting ticket, the number of remaining resting tickets owned by the livestreamer is decreased by one. Upon the start of the next round, the resting flag associated with the livestreamer is set to Y.

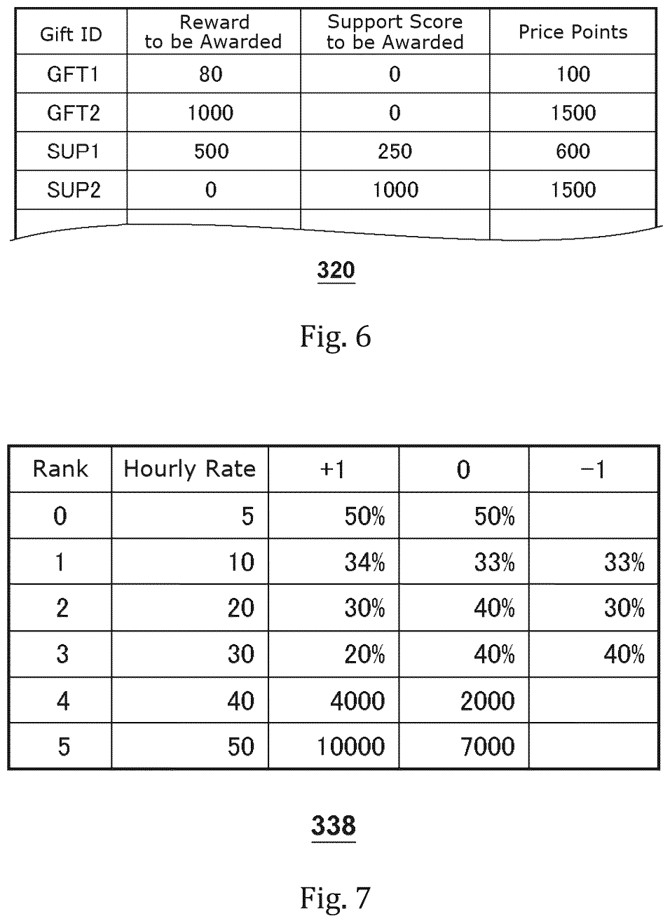

FIG. 6 is a data structure diagram showing an example of the gift DB 320 of FIG. 3. The gift DB 320 holds information regarding gifts available for the viewers in livestreams. A gift is a digital item or electronic data with the following characteristics:
It can be purchased in exchange for the points or money, or can be given for free.
It can be given by a viewer to a livestreamer. Giving a gift to a livestreamer is also referred to as using the gift or throwing the gift.
Some gifts may be purchased and used at the same time, and some gifts may be used by the viewer at any time after purchased.
When a viewer gives a gift to a livestreamer, the livestreamer is awarded a corresponding reward.
When a gift is used, the use may trigger an effect associated with the gift. For example, an effect corresponding to the gift will appear on the livestreaming room screen.

The gift DB 320 stores: a gift ID for identifying a gift; a reward to be awarded, which is a base value of the reward to be awarded to a livestreamer when the gift is given to the livestreamer; a support score to be given, which indicates the value of a support score to be given to a livestreamer when the gift is given to the livestreamer; and price points, which is the amount of points to be paid for use of the gift, in association with each other. A viewer is able to give a desired gift to a livestreamer by paying the price points of the desired gift while viewing the livestream. The payment of the price points may be made by appropriate electronic payment means. For example, the payment may be made by the viewer paying the price points to the administrator. Alternatively, bank transfers or credit card payments may be available. The administrator can freely determine the relationship between the reward to be awarded and the price points. For example, the administrator may determine that the reward to be awarded=the price points. Alternatively, points obtained by multiplying the reward to be awarded by a predetermined coefficient such as 1.2 may be set as the price points, or points obtained by adding predetermined fee points to the reward to be awarded may be set as the price points. In the present embodiment, when a viewer gives a gift to a livestreamer, the product of multiplying the reward to be awarded of the gift by the return rate of the livestreamer is added to the livestreamer's reward. For example, if the gift “GFT1” in FIG. 6 is given to a livestreamer who has a return rate of 0.4 (40%), the livestreamer receives a reward of 80 (base value)×0.4=32.

There are three types of gifts: gifts that increase the livestreamer's reward but do not affect the support score (GFT1 and GFT2 in FIG. 6), gifts that increase the livestreamer's reward and also increase the support score (SUP1 in FIG. 6), and gifts that do not affect the livestreamer's reward but increases the support score (SUP2 in FIG. 2). Since the gifts differ from each other in terms of whether they favorably affect the reward and support score, support actions by giving gifts can be more strategically performed. For example, a user may consider giving one of the gifts worth the same price points (GFT2 and SUP2 in FIG. 6). If the livestreamer is facing the risk of losing the current rank in the current round, the livestreamer will be more grateful for a gift) that considerably increases the support score (SUP2. On the other hand, if the livestreamer is highly likely to keep the current rank in the current round, the livestreamer will appreciate better a gift that will increase the reward more significantly (GFT2). A user (viewer) can feel satisfaction and delight by giving gifts that are more appreciated by the livestreamer.

FIG. 7 is a data structure diagram showing an example of the criteria DB 338 of FIG. 3. The criteria DB 338 stores criteria for evaluating the value of the support score of the livestreamer to determine whether to increase or decrease the livestreamer's rank score or keep the rank score unchanged. The criteria DB 338 stores, for each of the six ranks from 0 to 5, the hourly rate for the rank, the condition for the rank score to be changed by +1, the condition for the rank score to remain unchanged, and the condition for the rank score to be changed by −1. The hourly rate is the rate used to convert the streaming duration into a reward; the higher the rank, the higher the hourly rate.

The criteria stored in the criteria DB 338 include both relative and absolute criteria. Relative criteria are set for low ranks of the six different ranks, i.e., ranks 0, 1, 2, and 3. Absolute criteria are set for high ranks of the six different ranks, i.e., ranks 4 and 5. The high ranks are higher than the low ranks, and they do not overlap.

When the relative criteria are applied, whether a livestreamer's rank score increases, drops or remains unchanged is determined based on the result of comparing the value of the livestreamer's support score against the values of the support scores of the other livestreamers in the rank in which the livestreamer is currently in. In the example shown in FIG. 7, all of the livestreamers in rank 2 are ranked by their support score, the rank score of those in the top 30% is changed by +1, the rank score of those in the bottom 30% is changed by −1, and the rank score of the remaining 40% of the livestreamers remains unchanged.

When the absolute criteria are applied, whether a livestreamer's rank score increases, drops or remains unchanged is determined based on the result of evaluating the value of the livestreamer's support score independently from the values of the support scores of the other livestreamers. In the present embodiment, the value of the support score of the livestreamer is independently evaluated by comparing the value of the support score of the livestreamer against a threshold value that is a fixed value specific to the rank in which the livestreamer is. In other embodiments, the difference in the value of the support score between the previous round and the current round may be compared against a threshold value, or the increase rate of the support score may be compared against a threshold value. Referring to the example shown in FIG. 7, for each livestreamer in rank 4, if the value of the support score of the livestreamer is 4000 or more, the rank score of the livestreamer is changed by +1; if the value is between 2000 and 4000, the rank score remains unchanged; if the value is less than 2000, the rank score is changed by −1.

Referring again to FIG. 3, upon reception of a notification from the user terminal 20 of the livestreamer that the livestreamer starts a livestream over the network NW, the stream information providing unit 302 enters in the stream DB 314 a stream ID identifying this livestream and the livestreamer ID of the livestreamer who delivers the livestream. When the stream information providing unit 302 receives a request for information about livestreams from the out-of-livestream communication unit 404 of a user terminal of an active user over the network NW, the stream information providing unit 302 refers to the stream DB 314 and makes a list of currently available livestreams. The stream information providing unit 302 transmits the generated list to the requesting user terminal over the network NW. The out-of-stream UI control unit 402 of the requesting user terminal generates a livestream selection screen based on the received list and shows the livestream selection screen on the display of the user terminal.

Once the out-of-stream UI control unit 402 of the user terminal receives the active user's selection of a livestream on the livestream selection screen, the out-of-stream UI control unit 402 generates a stream request including the stream ID of the selected livestream, and transmits the stream request to the server 10 over the network NW. The stream information providing unit 302 starts providing, to the requesting user terminal, the livestream identified by the stream ID included in the received stream request. The stream information providing unit 302 updates the stream DB 314 such that the user ID of the active user of the requesting user terminal is included in the viewer IDs associated with the stream ID. In this way, the active user can be a viewer of the selected livestream.

The relay unit 304 relays the video data from the livestreamer's user terminal 20 to the viewer's user terminal 30 in the livestream started by the stream information providing unit 302. The relay unit 304 receives from the viewer-side communication unit 204 a signal that represents user input by a viewer during the livestream or reproduction of the video data. The signal that represents user input may be an object specifying signal for specifying an object displayed on the display of the user terminal 30, and the object specifying signal includes the viewer ID of the viewer, the livestreamer ID of the livestreamer of the livestream that the viewer watches, and an object ID that identifies the object. When the object is a gift icon, the object ID is a gift ID. The object specifying signal in that case is a gift use signal indicating that the viewer uses a gift for the livestreamer. When the object is a cheer icon, the object specifying signal is a cheer use signal indicating that the viewer uses a cheer for the livestreamer. Similarly, the relay unit 304 receives from the streamer-side communication unit 110 of the streaming unit 100 in the user terminal 20 a signal that represents user input by the livestreamer during reproduction of the video data, such as an object specifying signal.

The gift processing unit 308 updates the user DB 318 so as to increase the reward for the livestreamer according to the return rate and the reward to be awarded of the gift identified by the gift ID included in the gift use signal. Specifically, the gift processing unit 308 refers to the gift DB 320 to specify a reward to be awarded for the gift ID included in the received gift use signal. The gift processing unit 308 then updates the user DB 318 to add the product of multiplying the specified reward to be awarded by the return rate, to the reward for the livestreamer ID included in the gift use signal.

The payment processing unit 310 processes payment of a price of the gift by the viewer in response to reception of the gift use signal. Specifically, the payment processing unit 310 refers to the gift DB 320 to specify the price points of the gift identified by the gift ID included in the gift use signal. The payment processing unit 310 then updates the user DB 318 to subtract the specified price points from the points of the viewer identified by the viewer ID included in the gift use signal.

The support score updating unit 330 updates the value of the support score of a livestreamer based on support actions performed by a viewer for the livestreamer while the livestreamer is livestreaming. Upon reception of a gift use signal from the user terminal of a viewer watching an ongoing livestream, the support score updating unit 330 refers to the gift DB 320 to identify the support score to be awarded corresponding to the gift ID included in the received gift use signal. The support score updating unit 330 updates the user DB 318 to add the value of the identified support score to be awarded to the support score corresponding to the livestreamer ID included in the gift use signal. Upon reception of a cheer use signal from the user terminal of a viewer watching an ongoing livestream, the support score updating unit 330 identifies the support score to be awarded (a predetermined value such as 1, 10, 50 or the like) corresponding to the use of a cheer. The support score updating unit 330 updates the user DB 318 to add the value of the identified support score to be awarded to the support score corresponding to the livestreamer ID included in the cheer use signal. Upon reception of a comment input signal (described below) from the user terminal of a viewer watching an ongoing livestream, the support score updating unit 330 identifies the support score to be awarded (a predetermined value such as 1, 2, 3 or the like) corresponding to the input of the comment. The support score updating unit 330 updates the user DB 318 to add the value of the identified support score to be awarded to the support score corresponding to the livestreamer ID included in the comment input signal. The support score updating unit 330 periodically, e.g., once every 30 minutes, once every hour, etc., obtains the today's total viewed duration for each user, and identifies the support score to be awarded corresponding to the obtained total viewed duration (calculated at a predetermined rate such as 1 per hour). The support score updating unit 330 updates the user DB 318 to add the value of the identified support score to be awarded to the support score of each user. In other embodiments, the administrator can freely determine the relationship between the amount by which the support score is updated and the factors that cause the update, including gifts, comments, cheers, or viewed duration.

The support score updating unit 330 updates the value of the support score of a livestreamer based on support actions performed by other users for the livestreamer while the livestreamer is not livestreaming. The support actions performed by other users while the livestreamer is not livestreaming, i.e., outside livestreams, include out-of-livestream gifting and out-of-livestream cheering.

The livestreaming platform relating to the present embodiment is configured to allow a user to send a gift and a cheer to a livestreamer while the livestreamer is not livestreaming (hereinafter referred to as “out-of-livestream gift” and “out-of-livestream cheer”). The out-of-livestream gift and out-of-livestream cheer may be implemented using the technology disclosed in, for example, Japanese Patent No. 7272570. Upon reception of an out-of-livestream gift use signal indicating that an out-of-livestream gift is used from the user terminal of an active user, the support score updating unit 330 refers to the gift DB 320 to specify the support score to be awarded corresponding to the gift ID included in the received out-of-livestream gift use signal. The support score updating unit 330 updates the user DB 318 to add the specified support score to be awarded to the support score corresponding to the recipient user ID included in the out-of-livestream gift use signal. Upon reception of an out-of-livestream cheer use signal indicating that an out-of-livestream cheer is used from the user terminal of an active user, the support score updating unit 330 specifies the support score to be awarded (a predetermined value such as 1, 10, 50 or the like) corresponding to use of a cheer. The support score updating unit 330 updates the user DB 318 to add the specified support score to be awarded to the support score corresponding to the recipient user ID included in the out-of-livestream cheer use signal.

Even if the support score updating unit 330 receives a resting ticket from a livestreamer, the support score updating unit 330 continues to update the support score based on support actions performed for the livestreamer in the round designated by the restring ticket. This process is performed independently from the livestreamer's rank and from whether the support actions are taken within or outside livestreams. For example, even if the support score updating unit 330 receives a resting ticket designating the next round from a livestreamer in a high rank, the support score updating unit 330 continues to update the support score based on gifts and/or cheers sent to the livestreamer outside livestreams in the next round. Therefore, the support score of the livestreamer may change in the round where the livestreamer is resting.

At the closing time of a round, the low rank managing unit 332 determines, for a livestreamer in a low rank, whether to change the livestreamer's rank, based on the result of comparing the value of the support score acquired by the livestreamer in the round against the values of the support scores acquired by the other livestreamers in the rank into which the livestreamer is classified in the round.

At the closing time of a round, the low rank managing unit 332 refers to the user DB 318 to extract user IDs and support scores of users who are classified into any of the ranks 0 to 3 and who have the resting flag set to N, and generates a list of evaluation targets for each rank. The low rank managing unit 332 sorts the user IDs in the list by their support score. The low rank managing unit 332 refers to the criteria DB 338 and applies the relative criteria corresponding to each rank to the rank's list of sorted evaluation targets to identify users with a +1 rank score, users with a −1 rank score, and users with no increase or decrease in rank score. The low rank managing unit 332 updates the rank scores in the user DB 318 by changing the rank scores based on the identified rank score changes.

For each of the users who are classified into any one of the ranks 0 to 3 and who have their resting flag set to N, the low rank managing unit 332 changes the user's rank by +1 and resets the rank score to zero if the updated rank score reaches the upper limit. If the updated rank score reaches the lower limit, the low rank managing unit 332 changes the user's rank by −1 and resets the rank score to zero. The low rank managing unit 332 determines not to change the user's rank if the user's updated rank score is between the lower and upper limits.

In response to receiving a resting ticket designating a round from a livestreamer in a low rank, the low rank managing unit 332 does not perform the comparison-based rank change for the livestreamer in the designated round. At the closing time of the designated round, the low rank managing unit 332 identifies a user who is classified into any of the ranks 0 to 3 and who has the resting flag set to Y, and excludes the identified user from the users whose rank score or rank are to be updated in the round. The rank score and rank of the excluded user are thus not updated and remain unchanged.

At the closing time of a round, the high rank managing unit 334 determines, for a livestreamer in a high rank, whether to change the rank of the livestreamer based on the result of evaluating the value of the livestreamer's support score, independently of the values of the support scores of the other livestreamers.

At the closing time of a round, the high rank managing unit 334 refers to the user DB 318 to extract user IDs and support scores of users who are classified into any of the ranks 4 and 5 and who have the resting flag set to N, and generates a list of evaluation targets for each rank. The high rank managing unit 334 refers to the criteria DB 338 and applies the absolute criteria corresponding to each rank to each of the users in the rank's list individually to determine whether to change the rank score of the user by +1 or −1, or not to increase or decrease the rank score of the user. The high rank managing unit 334 compares, for each user ID included in the list of evaluation targets of a certain rank, the support score associated with the user ID against a threshold value or a fixed value specific to the rank and held in the criteria DB 338. The high rank managing unit 334 determines that the rank score be changed by +1 if the support score is equal to or greater than the +1 threshold value; changed by −1 if the support score is less than the −1 threshold value; and kept unchanged in other cases. The high rank managing unit 334 updates the rank scores by changing the rank scores in the user DB 318 based on the determined rank score changes.

For each of the users who are classified into any one of the ranks 4 and 5 and who have their resting flag set to N, the high rank managing unit 334 changes the user's rank by +1 and resets the rank score to zero if the updated rank score reaches the upper limit. If the updated rank score reaches the lower limit, the high rank managing unit 334 changes the user's rank by −1 and resets the rank score to zero. The high rank managing unit 334 determines not to change the user's rank if the user's updated rank score is between the lower and upper limits.

If the high rank managing unit 334 receives a resting ticket designating a round from a livestreamer in a high rank, the high rank managing unit 334 does not perform a rank change for the livestreamer in the designated round. At the closing time of the designated round, the high rank managing unit 334 identifies a user who is classified into any of the ranks 4 and 5 and who has the resting flag set to Y, and excludes the identified user from the users whose rank score or rank are to be updated in the round. The rank score and rank of the excluded user are thus not updated and remain unchanged.

At the closing time of a round, the reward awarding unit 336 performs operations for a livestreamer to award a number of rewards that is determined based on the livestreamer's rank and streaming duration, prior to the above-described process of updating the rank score and rank. The reward awarding unit 336 performs operations to award rewards to the livestreamer according to the livestreamer's hourly rate. Here, the hourly rate of the livestreamer increases as the rank of the livestreamer increases, and the rewards increase as the streaming duration of the livestreamer increases.

The reward awarding unit 336 identifies, for each user registered in the user DB 318, the hourly rate corresponding to the rank of the user and the total streaming duration in the closed round. The reward awarding unit 336 refers to the criteria DB 338 to identify the hourly rate corresponding to the rank. An upper limit (e.g., 3 hours) is set for the total streaming duration. If the total streaming duration stored in the user DB 318 exceeds the upper limit, the reward awarding unit 336 uses the upper limit as the total streaming duration. The reward awarding unit 336 calculates, for each user, a time-based reward for the closed round by multiplying the identified hourly rate by the identified total streaming duration. The reward awarding unit 336 updates the user DB 318 such that the time-based reward of the user is added to the reward of the user.

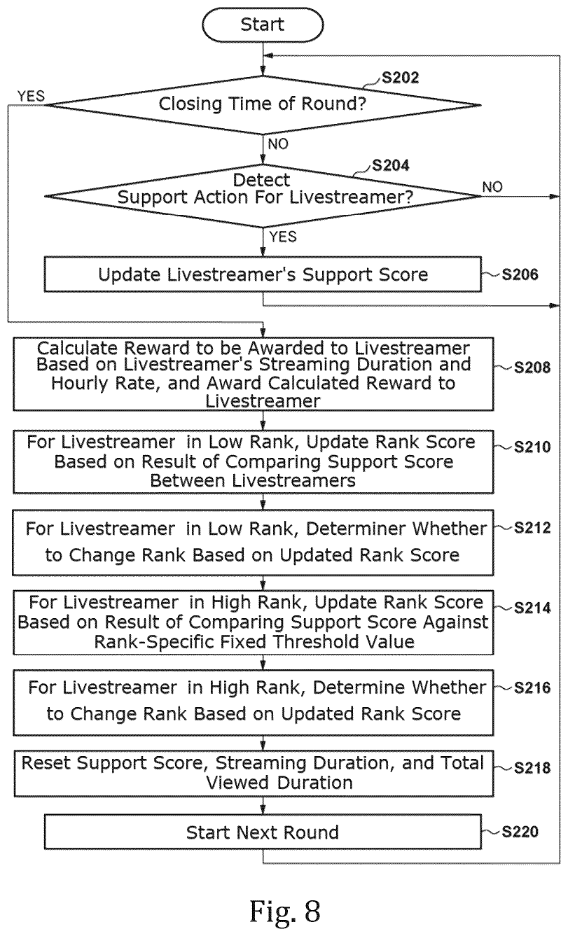

The following describes how the livestreaming system 1 with the above configuration works. FIG. 8 is a flowchart showing a series of steps performed to award a time-based reward in the livestreaming system 1. The server 10 determines whether it is the closing time of a round (S202). If it is not the closing time (N in S202), the server 10 determines whether a support action for a livestreamer (user) is detected (S204). If no support action is detected for the livestreamer (N in S204), the process returns to the step S202. If any support action is detected for the livestreamer (Y in S204), the server 10 updates the support score of the livestreamer (S206). The process then returns to the step S202.

If it is the closing time of a round (Y in S202), the server 10 calculates the reward to be awarded to the livestreamer based on the livestreamer's streaming duration and the hourly rate corresponding to the livestreamer's rank, and awards the calculated reward to the livestreamer (S208). The server 10 updates the rank scores of livestreamers in low ranks based on the result of comparing the support score between the livestreamers (S210). The server 10 determines, for the livestreamers in the low ranks, whether to change their ranks based on the updated rank scores (S212).

The server 10 updates, for livestreamers in high ranks, their rank scores based on the result of comparing their support scores against a rank-specific fixed threshold value (S214). The server 10 determines, for the livestreamers in the high ranks, whether to change their ranks based on the updated rank scores (S216).

The server 10 resets, for each livestreamer, the support score, streaming duration, and total viewed duration to their initial values (S218). The server 10 starts the next round (S220). The process then returns to the step S202.

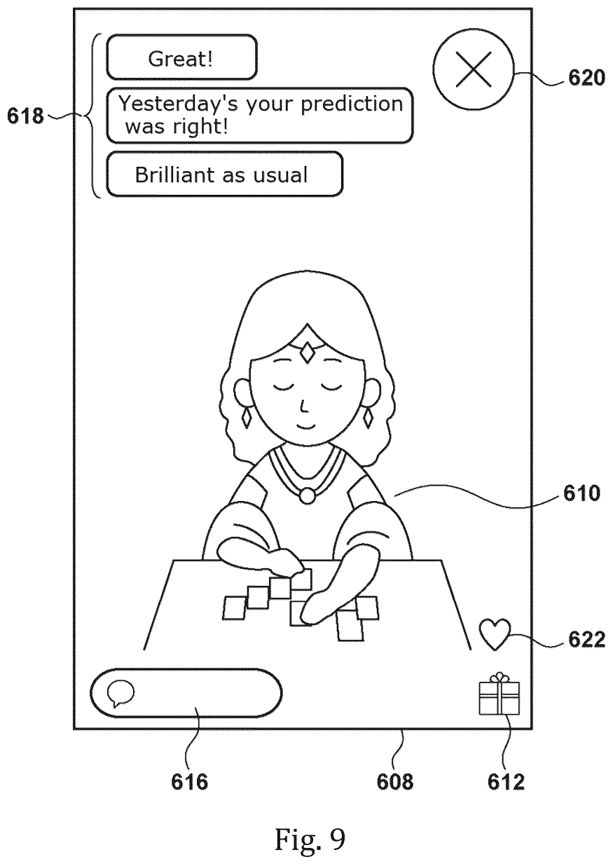

FIG. 9 is a representative screen image of a livestreaming room screen 608 shown on the display of the viewer's user terminal 30. The livestreaming room screen 608 displays a video image generated by the user terminal 20 of the livestreamer in real time. The livestreaming room screen 608 includes a video image 610 of the livestreamer provided by reproducing the video data received from the server 10, a gift icon 612, a comment input area 616, a comment display area 618, a quit viewing button 620, and a cheer object 622. The viewer-side UI control unit 202 superimposes objects such as the gift icon 612, the comment input area 616, the comment display area 618, the quit viewing button 620 and the cheer object 622 on the video image 610 obtained by reproducing the video data, thereby generating the livestreaming room screen 608.

The comment display area 618 may include a comment entered by the viewer and comments entered by other viewers, and notifications from the system. The notifications from the system may include information who gave which gift to the livestreamer. The viewer-side UI control unit 202 generates the comment display area 618 that includes comments posted by other viewers and received from the server 10 and notifications from the system, and the viewer-side UI control unit 202 includes the generated comment display area 618 in the livestreaming room screen 608.

The comment input area 616 receives a comment input by the viewer. The viewer-side communication unit 204 generates a comment input signal that includes the comment entered in the comment input area 616, and transmits the signal to the server 10 over the network NW. At the same time, the viewer-side UI control unit 202 updates the comment display area 618 to display the comment entered in the comment input area 616.

The quit viewing button 620 is an object for accepting an instruction from the viewer to quit viewing the livestream.

When a tap on the gift icon 612 is detected, the viewer-side UI control unit 202 of the user terminal 30 generates a gift information request and transmits the request to the server 10 over the network NW. Upon receipt of the gift information request, the relay unit 304 of the server 10 refers to the gift DB 320 and specifies available gift IDs. The server 10 generates gift information that includes the specified gift IDs, and transmits it to the user terminal 30 of the requester. The viewer-side UI control unit 202 of the user terminal 30 generates a gift area for receiving a gift selection based on the received gift information. The gift area includes gift objects representing the gifts identified by the gift IDs included in the received gift information. The viewer-side UI control unit 202 displays the generated gift area on the livestreaming room screen 608. The viewer may tap the gift object in the gift area, and the viewer-side UI control unit 202 of the user terminal 30 receives designation of the gift object by the viewer. The viewer-side UI control unit 202 generates an effect corresponding to the gift represented by the designated gift object. The viewer-side UI control unit 202 displays the generated effect on the livestreaming room screen 608. The viewer-side communication unit 204 generates a gift use signal including the gift ID of the gift represented by the designated gift object and transmits it to the server 10.

When a tap on the cheer object 622 is detected, the viewer-side communication unit 204 of the user terminal 30 generates a cheer use signal and transmits the cheer use signal to the server 10.

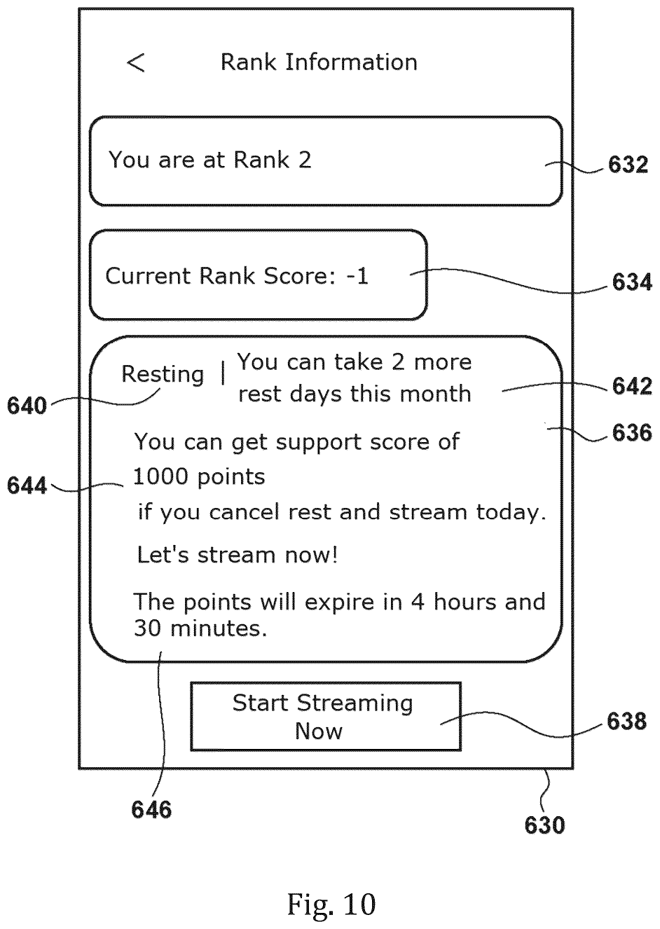

FIG. 10 is a representative screen image of a rank information display screen 630 shown on the display of the user terminal 20 of a livestreamer who is resting. On reception of a rank information view request from a livestreamer, the user terminal 20 generates a rank information request signal including the user ID indicative of the livestreamer and transmits the signal to the server 10 over the network NW. On reception of the rank information request signal, the stream information providing unit 302 obtains from the user DB 318 the support score, rank score, rank, today's total streaming duration, today's total viewed duration, resting flag, and number of remaining resting tickets that are stored in association with the user ID included in the rank information request signal. The stream information providing unit 302 generates a rank information response signal including the obtained information and transmits the signal to the requesting user terminal 20 over the network NW. Based on the information included in the received rank information response signal, the user terminal 20 generates and shows the rank information display screen 630 on the display. The rank information display screen 630 has a rank display area 632 that shows the livestreamer's current rank, a rank score display area 634 that shows the livestreamer's current rank score, a detailed information display area 636 that shows the livestreamer's status, and a start streaming button 638.

The information displayed in the detailed information display area 636 depends on whether the livestreamer is resting in the current round, that is to say, whether the resting flag in the rank information response signal is set to Y or N. If the resting flag is set to N, the detailed information display area 636 shows the progress of the relative or absolute criteria at the current time in the current round. If the resting flag is set to Y (FIG. 10), the detailed information display area 636 has information 640 indicating that the livestreamer is resting in the current round, the number of resting tickets 642 currently owned by the livestreamer, the value of support score 644 achieved through support actions performed for the livestreamer to the present in the current round, and the remaining time 646 until the closing time of the current round. The value of support score 644 is the value of support score achieved by gifts and cheers sent outside livestreams, if the livestreamer is not livestreaming in the current round. The detailed information display area 636 displays a text stating that the value of support score 644 can be obtained if the livestreamer cancels the rest and starts livestreaming in the current round. For example, the livestreamer may unexpectedly receive out-of-livestream gifts worth a large sum while resting. In this case, by seeing the information shown in the detailed information display area 636, the livestreamer may be motivated to start livestreaming to participate in the rank updating competition. In this way, the livestreamer can better take advantage of the opportunity to increase his or her rank or earn rank points. In other cases, the livestreamer may be thinking about canceling the rest for some reason when informed that he or she has acquired sufficient support score. This will encourage the livestreamer to restart livestreaming.

When detecting a tap on the start streaming button 638, the user terminal 20 generates a notification to start a livestream and sends it to the server 10 over the network NW.

In the above embodiment, the DBs may be implemented by, for example, hard disks or semiconductor memory. By reading the present disclosure, those skilled in the art would understand that each element or component can be realized by a CPU not shown, a module of an installed application program, a module of a system program, or a semiconductor memory that temporarily stores the contents of data read from a hard disk, and the like.

In the livestreaming system 1 relating to the present embodiment, relative evaluations are employed for ranks into which a relatively large number of livestreamers are sorted, and absolute evaluations are employed for ranks into which a relatively small number of livestreamers are sorted. The livestreamers can be thus evaluated in an optimal manner that is determined by the characteristics of the respective ranks.

In addition, the livestreaming system 1 relating to the present embodiment offers a hybrid reward system to livestreamers that combines distribution of profits through gifts and time-based rewards. The distribution of profits is a piece-rate reward that is equal to the result of multiplying the number of gifts received by a livestreamer by the livestreamer's return rate (ratio). The return rate is determined for each livestreamer and can vary among livestreamers, but is independent of rank, rank score or support score. Due to the hybrid reward system, the livestreaming platform can better accommodate different personalities of livestreamers and enable the livestreamers to develop more profitable strategies. For example, by setting a high return rate for a low rank, it is easier to attract livestreamers who are more apt to earn from a single jackpot than from a steady stream of money. The livestreaming platform also better attract livestreamers who prefer to earn steadily since their rank increases by steadily accumulating support scores even if the livestreamers have a low return rate.

In the livestreaming system 1 relating to the present embodiment, the support score of a livestreamer can be updated based on support actions performed for the livestreamer while the livestreamer is not livestreaming. This means that viewers can assist the livestreamer in reaching a higher rank both within and outside livestreams. This will increase the degree of freedom as to how the viewers support the livestreamer.

In the livestreaming system 1 relating to the present embodiment, the support score of a livestreamer continues to be updated even in a round where the livestreamer is resting. Therefore, when the livestreamer changes his/her mind and cancels the rest, the livestreamer can take advantage of out-of-livestream support actions. The livestreamer may change his/her mind in the latter half of the round. If the support score has already accumulated, this will make it less difficult for the livestreamer restart livestreaming.

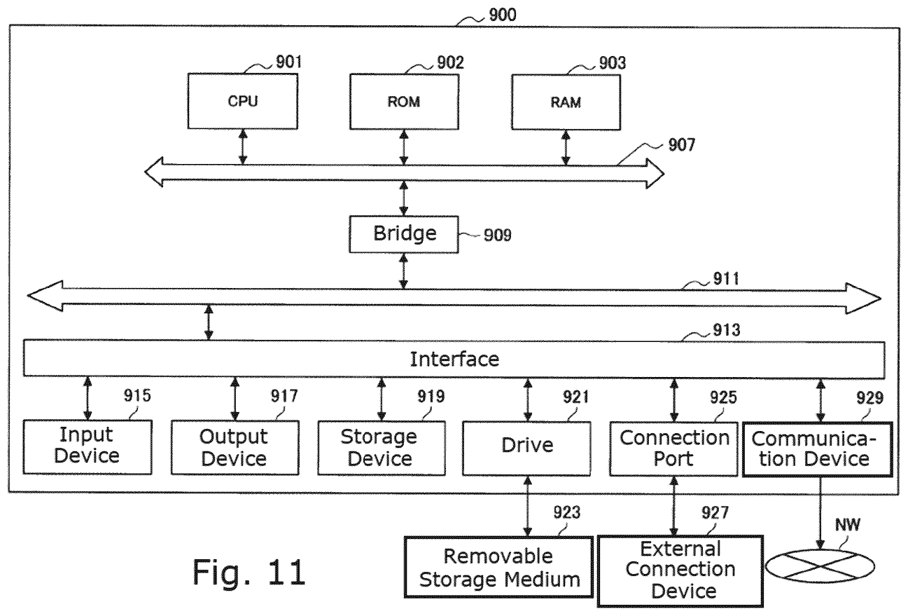

Referring to FIG. 11, the hardware configuration of an information processing device relating to an embodiment of the disclosure will be now described. FIG. 11 is a block diagram showing an example of the hardware configuration of the information processing device according to the embodiment. The illustrated information processing device 900 may, for example, realize the server 10 and the user terminals 20 and 30 in the embodiment.

The information processing device 900 includes a CPU 901, ROM (Read Only Memory) 902, and RAM (Random Access Memory) 903. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). The CPU 901 is an example of a hardware structure that can realize the functions performed by the constituent elements described herein. The functions described herein may be realized by circuitry programmed to realize such functions described herein. The circuitry programmed to realize such functions described herein includes a central processing unit (CPU), a digital signal processor (DSP), a general-use processor, a dedicated processor, an integrated circuit, application specific integrated circuits (ASICs) and/or combinations thereof. Various units described herein as being configured to realize specific functions, including but not limited to the livestreaming unit 100, the image capturing control unit 102, the audio control unit 104, the video transmission unit 106, the streamer-side UI control unit 108, the streamer-side communication unit 110, the viewing unit 200, the viewer-side UI control unit 202, the viewer-side communication unit 204, the out-of-stream processing unit 400, the out-of-stream UI control unit 402, the out-of-stream communication unit 404, the stream information providing unit 302, the relay unit 304, the gift processing unit 308, the payment processing unit 310, the support score updating unit 330, the low rank managing unit 332, the high rank managing unit 334, and the reward awarding unit 336 may be embodied as circuitry programmed to realize such functions.

The CPU 901 functions as an arithmetic processing device and a control device, and controls all or some of the operations in the information processing device 900 according to various programs stored in the ROM 902, the RAM 903, the storage device 919, or a removable recording medium 923. For example, the CPU 901 controls the overall operation of each functional unit included in the server 10 and the user terminals 20 and 30 in the embodiment. The ROM 902 stores programs, calculation parameters, and the like used by the CPU 901. The RAM 903 serves as a primary storage that stores a program used in the execution of the CPU 901, parameters that appropriately change in the execution, and the like. The CPU 901, ROM 902, and RAM 903 are interconnected to each other by the host bus 907 which may be an internal bus such as a CPU bus. Further, the host bus 907 is connected to the external bus 911 such as a PCI (Peripheral Component Interconnect/Interface) bus via the bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OELD, etc., a sound output device such as a speaker and headphones, and a printer. The output device 917 outputs the results of processing by the information processing device 900 as text, video such as images, or sound such as audio.

The storage device 919 is a device for storing data configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for the removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 903. Further, the drive 921 writes record in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is, for example, a camera for capturing an image of the real space to generate the captured image. The image capturing device uses an imaging element such as a CCD (Charge Coupled Device) or CMOS (Complementary Metal Oxide Semiconductor) and various elements such as lenses that are provided to control image formation of a subject on the imaging element. The image capturing device may capture a still image or may capture a moving image.

The configuration and operation of the livestreaming system 1 in the embodiment have been described. This embodiment is merely an example, and it will be understood by those skilled in the art that various modifications are possible by combining the respective components and processes, and that such modifications are also within the scope of the present disclosure.

According to the embodiment, the support score determines whether to change the rank score, and the rank score determines whether to change the rank. The present disclosure, however, is not limited to such. For example, whether to change the rank may be directly determined by relatively or absolutely evaluating the support score. In this manner, the rank may change more frequently.

In the present embodiment, the return rate is set for each livestreamer, different livestreamers may have different return rates, and the return rate for each livestreamer is determined independently from the rank, rank score or support score of the livestreamer. The present disclosure, however, is not limited to such. For example, the return rate can be a uniform value independent of livestreamers, or determined according to the rank.

The return rate of the gift, which indicates the ratio of the reward to be awarded to the price points in the embodiment, is merely an example, and the return rate may be appropriately set by the administrator of the livestreaming system 1, for example.

The technical idea according to the embodiment may be applied to live commerce or virtual livestreaming using an avatar that moves in synchronization with the movement of the streamer instead of the image of the streamer. In the present embodiment, the video data related to the livestream that is generated at the user terminal of the livestreamer is relayed by the server and sent to the user terminal of the viewer. The present invention, however, is not limited to such. For example, the technical ideas of the present embodiment can also be applied to a virtual livestreamer in place of an actual livestreamer. A virtual livestreamer is an AI virtual livestreamer having an appearance represented by an avatar, emitting audio produced by a text-to-speech (TTS) engine, and saying what is generated by a machine learning model receiving comments posted by viewers. In this case, the livestreamer has no user terminal, and the server performs the streamer-side processes.

The procedures described herein, particularly those described with a flow diagram or a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present invention.

At least some of the functions realized by the server 10 may be realized by a device(s) other than the server 10, for example, the user terminals 20 and 30. At least some of the functions realized by the user terminals 20 and 30 may be realized by a device(s) other than the user terminals 20 and 30, for example, the server 10. For example, the superimposition of a predetermined frame image on an image of the video data performed by the viewer's user terminal may be performed by the server 10 or may be performed by the livestreamer's user terminal.

What is claimed is:

1. A server for providing a livestreaming platform, the server comprising a circuitry, wherein the circuitry is configured to:
determine, for a first livestreamer in a first rank of a plurality of ranks, whether to move the first livestreamer from the first rank to a different one of the plurality of ranks, based on a result of comparing a value of a support parameter indicating an amount of support the first livestreamer receives and a value of a support parameter of a different livestreamer in the first rank;
determine, for a second livestreamer in a second rank of the plurality of ranks, whether to move the second livestreamer from the second rank to a different one of the plurality of ranks, based on a result of evaluating a value of a support parameter of the second livestreamer independently of a value of a support parameter of a different livestreamer; and
perform an operation to award a reward to a livestreamer, the reward being calculated based on a rank of the livestreamer and a streaming duration of the livestreamer.

2. The server of claim 1, wherein the reward is calculated according to a rate that increases as the rank of the livestreamer increases, and the reward increases as the streaming duration of the livestreamer increases.

3. The server of claim 2, wherein the second rank is higher than the first rank.

4. The server of claim 1, wherein the circuitry is configured to determine, for the second livestreamer in the second rank of the plurality of ranks, whether to move the second livestreamer from the second rank based on a result of comparing a value of a support parameter acquired by the second livestreamer within a second period and a threshold value that is a fixed value specific to the second rank.

5. The server of claim 4,
wherein the circuitry is configured to determine, for the first livestreamer in the first rank of the plurality of ranks, whether to move the first livestreamer from the first rank based on a result of comparing a value of a support parameter acquired by the first livestreamer within a first period and a value of a support parameter acquired by a different livestreamer in the first rank within the first period, and
wherein the second period is different in length from the first period.

6. The server of claim 1, wherein the circuitry is further configured to update a value of a support parameter of a livestreamer based on a support action performed for the livestreamer while the livestreamer is not livestreaming.

7. The server of claim 4,
wherein the circuitry is further configured to update a value of a support parameter of a livestreamer based on a support action performed for the livestreamer while the livestreamer is not livestreaming,
wherein the circuitry is configured to, in response to receiving a resting request designating the second period from the second livestreamer in the second rank of the plurality of ranks, prevent the second livestreamer from moving from the second rank based on the result of comparing in the second period, and
wherein the circuitry is configured to, despite receiving the resting request designating the second period from the second livestreamer in the second rank of the plurality of ranks, continue to update the support parameter of the second livestreamer based on a support action performed for the second livestreamer in the second period.

8. A method performed in a server for providing a livestreaming platform, the method comprising:
determining, for a first livestreamer in a first rank of a plurality of ranks, whether to move the first livestreamer from the first rank to a different one of the plurality of ranks, based on a result of comparing a value of a support parameter indicating an amount of support the first livestreamer receives and a value of a support parameter of a different livestreamer in the first rank;
determining, for a second livestreamer in a second rank of the plurality of ranks, whether to move the second livestreamer from the second rank to a different one of the plurality of ranks, based on a result of evaluating a value of a support parameter of the second livestreamer independently of a value of a support parameter of a different livestreamer; and
performing an operation to award a reward to a livestreamer, the reward being calculated based on a rank of the livestreamer and a streaming duration of the livestreamer.

9. The method of claim 8, wherein the reward is calculated according to a rate that increases as the rank of the livestreamer increases, and the reward increases as the streaming duration of the livestreamer increases.

10. The method of claim 9, wherein the second rank is higher than the first rank.

11. The method of claim 8, wherein, for the second livestreamer in the second rank of the plurality of ranks, whether to move the second livestreamer from the second rank is determined based on a result of comparing a value of a support parameter acquired by the second livestreamer within a second period and a threshold value that is a fixed value specific to the second rank.

12. The method of claim 11,
wherein, for the first livestreamer in the first rank of the plurality of ranks, whether to move the first livestreamer from the first rank is determined based on a result of comparing a value of a support parameter acquired by the first livestreamer within a first period and a value of a support parameter acquired by a different livestreamer in the first rank within the first period, and
wherein the second period is different in length from the first period.

13. The method of claim 8, further comprising
updating a value of a support parameter of a livestreamer based on a support action performed for the livestreamer while the livestreamer is not livestreaming.

14. The method of claim 11, further comprising
updating a value of a support parameter of a livestreamer based on a support action performed for the livestreamer while the livestreamer is not livestreaming,
wherein, in response to receiving a resting request designating the second period from the second livestreamer in the second rank of the plurality of ranks, the second livestreamer is prevented from moving from the second rank based on the result of comparing in the second period, and
wherein, despite receiving the resting request designating the second period from the second livestreamer in the second rank of the plurality of ranks, the support parameter of the second livestreamer continues to be updated based on a support action performed for the second livestreamer in the second period.
